(19) United States
(12) Patent Application Publication
(10) Pub. No.: US 2023/0033232 A1
(43) Pub. Date: Feb. 2, 2023

(54) COMPUTER-ASSISTED METHOD AND DEVICE FOR CONTROLLING A CONCRETE MIXING FACILITY

(71) Applicant: PERI SE, Weissenhorn (DE)

(72) Inventors: Henning Staves, Weissenhorn (DE); Helmut Baechle, Weissenhorn (DE)

(21) Appl. No.: 17/784,955

(22) PCT Filed: Dec. 10, 2020
(86) PCT No.: PCT/EP2020/085500

§ 371 Date: Jun. 13, 2022

(30) Foreign Application Priority Data
Dec. 11, 2019 (DE) 10 2019 219 373.0

(51) Int. Cl. B28C 7/02; B28C 7/04; B28C 5/20; C04B 40/00

(52) U.S. Cl. CPC B28C 7/024; B28C 7/0409; B28C 7/0418; B28C 5/20; C04B 40/0032

(57) ABSTRACT

The invention relates to a computer-aided method and a device for controlling a concrete mixing plant for the production of ready-mixed concrete (1) or mixed concrete, which is mixed at least from the components cement (6a; 6b) and aggregates (8a, 8b, 8c) with the addition of water (9) in a motor-driven mixer unit (3), wherein at least the required mixing time (t_{M}) of the mixer unit (3) is calculated before the start of the mixing process by means of an electronic prognosis unit (10), which calculates the current moisture (F), measured by means of at least one moisture sensor (11), of at least the aggregates (8a, 8b, 8c) to be added and the temperature measured by means of at least one temperature sensor (12;13;14) or thermal imaging camera, in order to determine the required mixing time (t_{M}) of the mixer unit (3) on the basis of a predetermined concrete formulation (18), taking into account the various measured values determined by the sensors.

### REFERENCE TO RELATED APPLICATIONS

This application claims priority to German Patent Application No. 10 2019 219 373.0, filed Dec. 11, 2019, which is incorporated herein by reference in its entirety.

The present invention relates to a computer-assisted method for controlling a concrete mixing plant for the production of ready-mixed concrete or mixed concrete, which is mixed from at least the components cement and aggregates with the addition of water in a motor-driven mixing unit. In addition, the invention also relates to a data processing device executing the control method and to a computer program embodying the method. Furthermore, the invention comprises a special data format generated by the device for a documentation data set of the concrete quality produced and delivered by a concrete mixing unit.

The field of application of the invention extends to concrete mixing plants as well as to transport logistics between a concrete mixing plant for the production of ready-mix concrete and the construction site where the ready-mix concrete is delivered and placed.

### PRIOR ART

A concrete mixing plant usually consists essentially of several silos and open-air storage areas where the components to be mixed are stockpiled. Powdered cement, for example, is stored in silos to protect it from moisture, and the aggregates, preferably gravel and sand, are stored outdoors in the form of bulk stockpiles. From here, depending on the design of the concrete mixing plant, the aggregates can also be conveyed to silos, for example via a conveyor belt system. Different groups of aggregates are stored separately in their respective silos. From the silos, the components are conveyed to the mixer unit in accordance with a concrete formula to be produced, with appropriate addition of water.

The mixer unit can be designed, for example, as a drum mixer, free-fall mixer, ring trough mixer, plate mixer, pan mixer or the like. At the end of a mixing period usually determined by the mix design, the ready-mix concrete is filled into truck mixers which are to transport it to the construction site as punctually as possible.

So-called concrete admixtures are also used as further components for the production of ready-mix concrete, which must be stored separately from the aforementioned components. The same applies analogously to so-called concrete admixtures, for example fly ash, limestone powder or the like.

According to the generally known state of the art, the dosing of the above-mentioned components is usually carried out by an operator in the control station of the concrete mixing plant and is semi-automated according to a written mixing instruction, i.e. the concrete recipe.

For batch sizes of more than 1 m³, strict rules apply to the proportioning of the components. For example, the components cement, aggregates, water and additives must be metered with a tolerance of ±3% of the required quantity in order to achieve the desired concrete quality. The batching process is computer-aided according to instructions, and when controlling the mixing time, care must be taken to ensure that changes in the properties of the components, such as moisture of the aggregates, trigger a corresponding adjustment of added quantities.

The mixing of the components must be carried out by the motor-driven mixer unit until the mixture appears uniform. This period is the mixing time t_{M} , which is usually determined according to empirical values and is at least 30 seconds for normal concrete and at least 90 seconds for lightweight concrete.

Of course, the required mixing time t_{M} also depends on the shape and movement of the mixing unit, for example the speed of a drum mixer. These parameters vary depending on the concrete mixing plant and the mixing technology used there. Therefore, the above empirical values are not generally valid. If, to be on the safe side, an excessively long mixing time is selected, optimum mixing of the components will be achieved, but the longer plant time requires a correspondingly higher effort and, for example, the quality of the ready-mixed concrete may suffer due to premature setting as a result of an additionally long transport time caused by dust.

In addition, longer mixing times may be required for the production of concretes with special requirements, such as self-compacting concretes, high-strength concretes, fair-faced concretes or when air-entrained patterns are used. Concrete admixtures usually have to be added during the mixing process. If superplasticizer is added during the mixing process, the concrete must continue to be mixed until the superplasticizer is completely dispersed in the mix. Depending on the plant technology, concrete admixtures are added either together with the water supply or immediately afterwards. Usually, the effect depends on the time of addition.

In addition, other circumstances also influence the required mixing time t_{M} of the mixer unit and the associated quality of the ready-mix concrete produced. For example, aggregates heated up in summer due to solar radiation can result in ready-mix concrete that is much too hot and may begin to set before the end of the transport period. Although this can be counteracted by adding dry ice or by watering the aggregates, the achievable results are not always reliably attainable due to the other influencing parameters mentioned above.

It is therefore an objective of the present invention to create a method as well as a device for the computer-aided control of a concrete mixing plant, which ensures a concrete quality that is as uniform as possible for different concrete formulations despite different or changing influencing parameters.

### DISCLOSURE OF THE INVENTION

The objective is solved by a computer-assisted method according to claim 1. With respect to a device for data processing executing the method, reference is made to claim 10. Claim 16 relates to a concrete mixing plant for the production of ready-mixed concrete, which comprises such a device. Furthermore, a special data format for a documentation record of a concrete mixing plant is proposed and claim 18 relates to a computer program embodying the method according to the invention.

The invention includes the process-engineering teaching that the required mixing time t_{M} of the mixer unit as a quality-determining factor for a ready-mixed concrete produced in a concrete mixing plant is calculated before the start of the mixing process via an electronic prognosis unit from the relevant influencing parameters, which not only takes into account the current moisture F of at least the added aggregates measured via at least one moisture sensor, but also the component temperature T_{K} measured or determined via at least one temperature sensor or a thermal imaging camera, the mixer temperature T_{M} and/or the outside temperature T_{A} in order to determine the required mixing time t_{M} of the mixer unit and the concrete quality to be expected on a batch-size-specific basis on the basis of a specified concrete formula, taking into account the various measured values determined by the sensors. If a thermal imaging camera is used instead of a temperature sensor, this can be mounted below or next to a mixer drum or the like, for example, to detect the mixer temperature T_{K}. In this way, existing concrete mixing plants can also be retrofitted with the technology according to the invention with regard to the required hardware at reasonable expense.

In other words, the solution according to the invention includes an optimum prognosis of the mixing duration t_{M} of a concrete mixing plant as a quality-determining factor for a ready-mixed concrete to be produced by comparing measured values of various sensors, in particular a moisture sensor for determining the moisture of the aggregates as well as at least one temperature sensor for determining process temperatures and/or sensors for other process parameters. It has been found that these essential measured variables have a significant influence on the achievable concrete quality, so that the concrete quality can be made comparable by adjusting the mixing time t_{M} accordingly. For example, the mixing process can be shortened at high outside temperatures while increasing the water addition. Preferably, therefore, the required mixing time t_{M} is predicted with further consideration of correction curves for parameters relevant to the mix design.

Furthermore, it is proposed that the required mixing duration t_{M} is transmitted directly from the prognosis unit to the control unit of the mixer unit for controlling the same. The control unit can also vary the rotational speed of a drum-shaped mixer unit to subsequently extend or shorten the predicted required mixing duration t_{M}. For example, if temperature readings increase abnormally during the mixing process, the normal rotational speed of the mixer unit can be increased to subsequently shorten the mixing duration. This also shortens the heat effect. Likewise, the control unit adjusts the addition of water to the measured moisture content of the aggregates.

For example, temperature-mixing time correction curves, speed-mixing time correction curves and the like are used as correction curves for recipe-relevant parameters. These curves are used to vary the mixing time t_{M} as a function of parameters such as the temperature or the speed of a drum-type mixing unit, which influence the concrete quality.

According to a further measure improving the invention, it is proposed that the electronic forecasting unit not only calculates the mixing time t_{M}, but also forecasts the transport time t_{T} of the ready-mixed concrete from the concrete mixing plant to the construction site. Since the order information for the ready-mixed concrete also makes it possible to know the delivery location and the desired delivery time, the electronic forecasting unit can use a route planning unit to estimate the current travel time of a truck mixer due to traffic conditions.

As a further influencing parameter, the electronic prognosis unit can also take into account the estimated transport temperature curve based on the outside temperature and, optionally, an estimated waiting time until the ready-mix concrete is placed on the construction site. A waiting time can result, for example, from the fact that a formwork has not yet been completed at the construction site or the shoring of earlier deliveries of ready-mix concrete is delayed. Since the outside temperature during transport also has a decisive influence on the concrete quality, this is also taken into account. By means of the prognosis unit, the concrete quality can thus be predicted and, if necessary, influenced along the entire production chain, namely from the storage of the material, the start of the mixing process to the shoring on the construction site, in order to achieve uniform qualities. If, for example, a longer transport time t_{T} is required due to dust, the prognosis unit reacts by specifying concrete admixtures to extend the pot life of the ready-mixed concrete, which can be added during the mixing process as specified by the control unit within the framework of the specified concrete recipe.

Since the prognosis unit is able to determine the concrete quality that can be realized under the given circumstances for the concrete recipe to be used on the basis of the measured values determined by the sensor system and other process-influencing parameters, this quality can be communicated to the person responsible on the construction site before mixing and subsequent transport so that he can decide whether or not the concrete quality that can be realized under the given circumstances should be used. In this way, incorrect deliveries can be avoided.

This process can advantageously be carried out by a computer-aided matching unit connected to the forecast unit, which compares the forecast realizable concrete quality with the specification required for the construction site before filling the mixer unit with the components to be mixed the start of the mixing process.

According to a further measure improving the invention, it is proposed that at least the information generated by the sensor system, the prognosis unit, the control unit and the adjustment unit concerning a mixing and delivery process of ready-mixed concrete is stored in a documentation database so that it can be retrieved. For this purpose, a special data format is proposed for a documentation data record which comprises at least the following essential data fields assigned to an order identifier as data record key:
Used concrete formulation,
Temperature readings during the mixing and/or transport process,
Humidity readings of at least one component used in the concrete mix design,
Quantities of all components used in the concrete mix design,
Predicted you performed mixing duration t_{M} of the mixer unit, and
Transport time to and waiting time at the construction site.

This special data format thus comprises the core information that is decisive for the concrete quality of a delivery. In addition, further data can of course also be added to the documentation data record. Furthermore, such documentation data records can be analyzed with a correspondingly high data stock in terms of the conditions under which optimum concrete qualities could be achieved from order processes. From this, a pattern recognition system can automatically suggest countermeasures for eliminating negative influences as part of a machine learning process in order to ensure a higher probability of optimum concrete qualities in the future. Such a countermeasure can, for example, be an increased addition of water at slow speeds, a shortened mixing time at low temperatures or the like. All such countermeasures are not readily recognizable at all on the basis of human intellect alone with the wealth of experience of a specialist.

Furthermore, the documentation data set can also be linked to other construction-relevant data via blockchain technology and stored in a documentation database in a tamper-proof manner for all parties involved in a construction project.

### DETAIL DESCRIPTION BASED ON THE DRAWING

Further measures improving the invention are shown in more detail below together with a description of a preferred embodiment of the invention with reference to the figures. It shows:

FIG. 1 a schematic representation of a concrete mixing plant with computer-aided control equipment implemented therein,

FIG. 2 a schematic flow chart of a method for controlling the concrete mixing plant according to FIG. 1, and

FIG. 3 a data format of an order record for the concrete mixing plant.

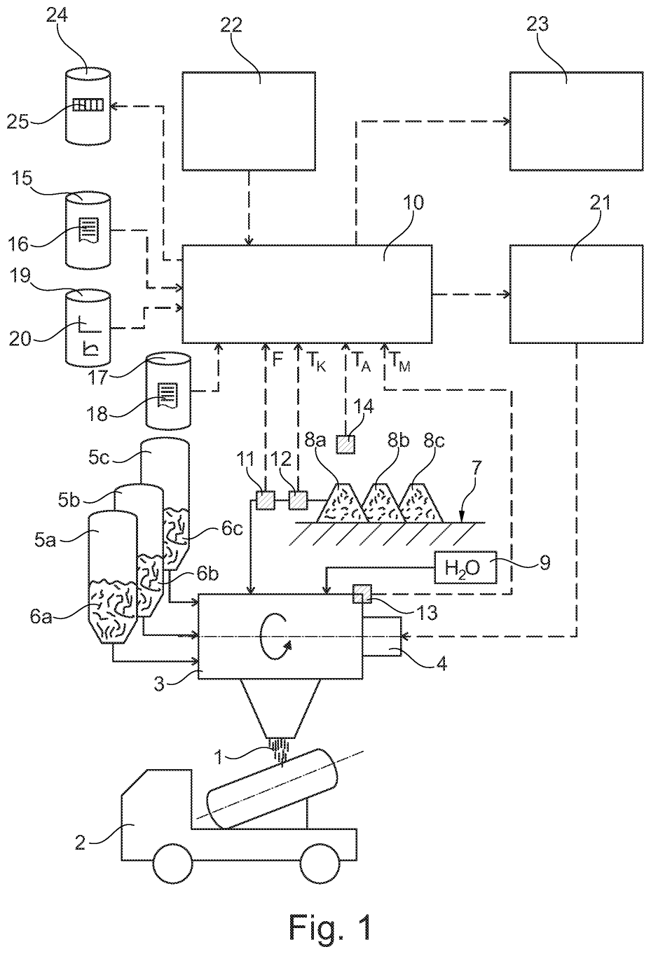

According to FIG. 1, a concrete mixing plant for the production of ready-mixed concrete 1, which is transported from there by truck mixer 2 to a construction site—not further shown here—for shoring, essentially consists of a mixer unit 3, which is designed here as a drum mixer, which can be set in rotary motion for mixing by means of an electric drive motor 4.

For the supply of components to be mixed, the mixer unit 3 is in connection with cement silos 5a to 5c, which contain different types of cement 6a; 6b; 6c, which are injected into the mixer unit 3 in a valve-controlled manner via a compressed air conveying device. In addition, the mixer unit 3 is in material flow connection with a stockpile area 7, on which bulk material stockpiles with different aggregates 8a to 8c, i.e. different gravels and sands, are stored. These are transported to the mixer unit 3 by conveyor belt equipment. In addition, the mixer unit 3 can be connected to a connection for water 9.

For the calculation of a required mixing time t_{M} for the operation of the mixer unit 3, an electronic prognosis unit 10 is provided within the control system of the concrete mixing plant. On the input side, the electronic prognosis unit 10 in this embodiment example is connected to a moisture sensor 11 for measuring the current moisture F of the aggregate 8a; 8b; 8c to be fed. In addition, the component temperature T_{K} of the aggregate 8a; 8b; 8c to be fed is measured via temperature sensor 12. In addition, the process temperature inside the mixer unit3 is also monitored via a further temperature sensor 13, as is the outside temperature TA via a temperature sensor 14. At this point, it should be pointed out once again that, within the scope of the solution according to the invention, only a partial selection of these sensors or additional sensors can also be provided, which report measured values relevant to the mixing duration to the electronic prognosis unit 10.

Based on a ready-mix concrete order 16 stored and to be processed within an order database 15, the electronic forecasting unit 10 determines the associated concrete recipe 18, for example for a special lightweight concrete, which can be retrieved from a recipe database 17.

In addition, the various measured values determined by the sensor system described above are fed to the prognosis unit 10. Based on this, the prognosis unit 10 determines at least the required mixing duration t_{M} of the mixer unit 3 at a specific nominal speed. In addition, other control data can also be predicted.

When determining the control data, the prognosis unit 10 also takes into account correction characteristics 19, which are stored in a correction line database 20 so that they can be called up. For example, a temperature-mixing time correction curve can be used to extend the mixing time t_{M} with increased water addition, for example, if unusually dry and heated components are used. The same applies in the opposite case.

The required mixing duration t_{M} predicted by the prognosis unit 10 is then transmitted to the control unit 21 of the mixer unit 3 for controlling the motor 4 at a defined nominal speed. In addition, it is also possible for the control unit 21 to lower or increase the speed of the electric motor 4 in order to vary the predicted required mixing duration t_{M}. If, for example, a truck mixer 2 is not yet available to accept the ready-mixed concrete 1, the rotational speed of the mixer unit3 can be lowered during the waiting time.

In addition, in this embodiment, the electronic forecasting unit 10 also takes into account a transport time t_{T} from the stationary concrete mixing plant to the construction site, which is forecast on the basis of a route planning unit 22 and results from the route planning data. This can also be used to vary the required mixing time t_{M} accordingly. In addition, concrete admixtures that extend the potting time can be added as part of the concrete mix design 18 if it turns out that the delivery of the ready-mixed concrete 1 to the construction site would take longer due to traffic. This ensures that the concrete quality used is as uniform as possible.

A matching unit 23, also connected to the prognosis unit 10, compares the prognosticated realizable concrete quality with the specification required for the construction site, which results from the ready-mix concrete order 16. If this specification is not achievable, there is a possibility that a start of the filling and mixing process is prevented, since it is foreseeable that the required concrete quality is not achievable in view of an extreme heating of components in the summer time or a delayed transport time due to dust. This information generated by the adjustment unit 23 can also be transmitted to the construction site, for example, for the purpose of changing the construction schedule.

Furthermore, it is provided that the information generated by the sensor system, the prognosis unit 10, the control unit 21 as well as the adjustment unit 23 regarding a mixing and delivery process of ready-mixed concrete 1 is stored in a documentation database 24 in a retrievable manner, which ensures later verifiability.

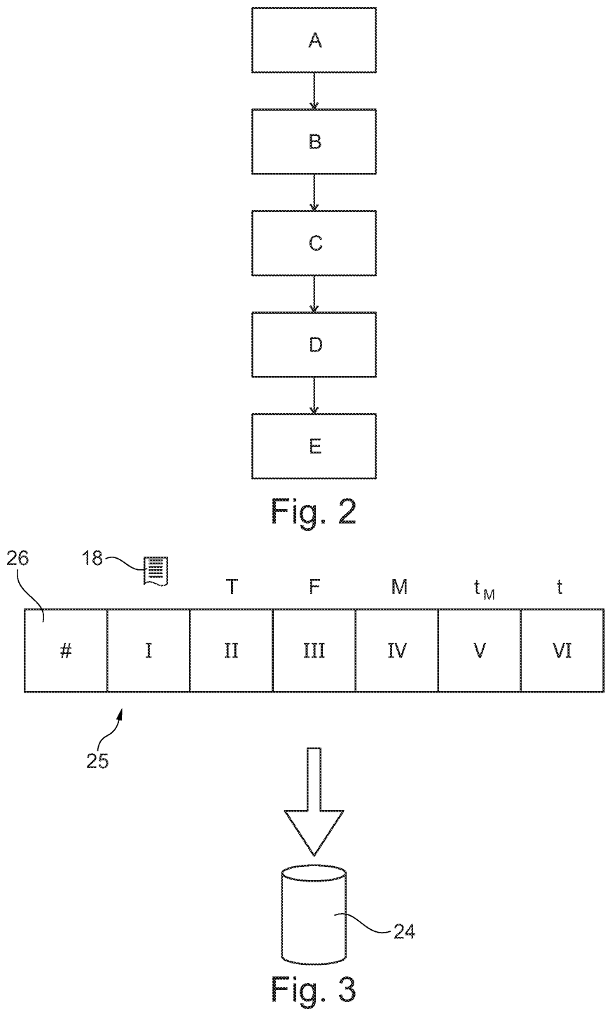

According to FIG. 2, the method for controlling a concrete mixing plant for the production of ready-mix concrete 1 comprises at least the following steps:

In step A, the concrete recipe to be produced is first loaded for the execution of a ready-mix concrete order. In step B, various current measured status values of the required components are read in via the sensors of the concrete mixing plant. Based on these values, at least the required mixing time is predicted in a step C. The result of this prognosis is used as a basis for the concrete mix. In step D, this result is corrected by further logistic influencing parameters. In step E, the mixture is filled into a truck mixer for transport to the construction site.

According to FIG. 3, a data format of an order record 25 for a concrete batching plant for the production of ready-mixed concrete includes the following data fields associated with an order identifier 26, which are also archived in the documentation database 24:

The concrete formulation 18 used is stored in a data field I, the measured temperature values T during mixing and/or transport are stored in a data field II, the measured moisture values F of at least one component used in the concrete formulation are stored in a data field III, the actual quantities M of all components used according to the concrete formulation are stored in a data field IV, the predicted mixing time t_{M} of the mixer unit is stored in a data field V, and the total transport and waiting time t of the ready-mixed concrete to or at the construction site is stored in a data field VI.

This concentrated data set documents essential quality information about an ordered and used ready-mix concrete, which is also accessible for later evaluation in terms of pattern recognition, damage analysis, formulation improvements and the like.

The invention is not limited to the preferred embodiment described above. On the contrary, variations thereof are also conceivable, which are included in the scope of protection of the following claims. For example, it is also conceivable, in addition to or instead of the concrete quality-determining control parameter of the required mixing time t_{M} , to predict other or further variables, such as the actually required quantities of the individual components of the concrete. In the event of cold weather conditions at the construction site, the concrete mix can also be specifically preheated, for example. Thanks to the solution according to the invention, the quality of a concrete delivery can also be made an enforceable contractual condition of a so-called smart contract and secured along the production and utilization chain using blockchain technology.

### LIST OF REFERENCE SIGNS

1 Transport concrete
2 Driving mixer
3 Mixing unit
4 Electric motor
5 Silo
6 Cement
7 Dump area
8 Grain aggregate
9 Water
10 Forecast unit
11 Humidity sensor
12 First temperature sensor
13 Second temperature sensor0
14 Third temperature sensor
15 Ordering database
16 Transport concrete order
17 Recipe database
18 Concrete recipe
19 Correction characteristic
20 Correction characteristics database
21 Control unit
22 Route planning unit
23 Adjustment unit
24 Documentation database
25 Documentation record
26 Order identifier

1. Computer-aided method for controlling a concrete mixing plant for the production of ready-mixed concrete (1) or mixed concrete, which is mixed at least from the components cement (6a; 6b) and aggregates (8a, 8b, 8c) with the addition of water (9) in a motor-driven mixer unit (3),
characterized in that at least the required mixing time (t_{M}) of the mixer unit (3) is calculated before the start of the mixing process by means of an electronic prognosis unit (10), which considers the current moisture (F) of at least the aggregates (8a, 8b, 8c) to be added, measured via at least one moisture sensor (11), and the component temperature (T_{K}), the mixer unit temperature (T_{M}) and/or the outside temperature (T_{A}) measured or determined via at least one temperature sensor (12;13;14) or thermal imaging camera, in order to determine the required mixing time (t_{M}) of the mixer unit (3) on the basis of a predetermined concrete formulation (18), taking into account the various measured values determined by the sensors.

2. Method according to claim 1,
characterized in that the prognosis of the required mixing time (t_{M}) is carried out with further consideration of correction characteristic curves (19) for parameters relevant to the formulation.

3. Method according to claim 1,
characterized in that the required mixing time (t_{M}) is transmitted from the prognosis unit (10) to the control unit (21) of the mixer unit (3) for activation.

4. Method according to claim 1,
characterized in that the control unit (21) varies the rotational speed of a drum-shaped mixer unit (3) to subsequently extend or shorten the predicted required mixing time (t_{M}).

5. Method according to claim 1,
characterized in that a transport time (t_{T}) from the stationary concrete mixing plant to a construction site predicted on the basis of a route planning unit (22) and/or an estimated transport temperature profile of the ready-mixed concrete (1) and/or an estimated waiting time until the ready-mixed concrete (1) is placed on the construction site is also taken into account in the calculation by the electronic prognosis unit (10).

6. Method according to claim 1,
characterized in that the control unit (21) controls the addition of water (9) according to the concrete recipe (18) and taking into account the measured moisture of at least the aggregates (8a, 8b, 8c) or other components to be added.

7. Method according to claim 1,
characterized in that the concrete quality that can be realized under the given circumstances is determined by the prognosis unit (10) for the concrete formulation (18) to be implemented on the basis of the measured values determined by the sensor system.

8. Method according to claim 1,
characterized in that a comparison unit (23) compares the predicted realizable concrete quality with the specification required for the construction site before the mixing process is started.

9. Method according to claim 1,
characterized in that at least the information generated by the sensor system, the prognosis unit (10), the control unit (21) and the adjustment unit (22) concerning a mixing and delivery process of ready-mixed concrete (1) is stored in a documentation database (24) so that it can be retrieved.

10. Data processing device for controlling a concrete mixing plant for producing ready-mixed concrete (1) or mixed concrete, which a motor-driven mixer unit (3) produces from at least the components cement (6a; 6b) and aggregates (8a, 8b, 8c) with the addition of water (9), the components being stored in respective silos (5a, 5b) connected to the material flow of the mixer unit(3) and/or on at least one stockpile surface (7),
characterized in that an electronic prognosis unit (10) for calculating the required mixing time (t_{M}) of the mixer unit (3) is provided, which takes into account the current moisture (F) of at least the aggregates (8a; 8b; 8c) to be added, measured via at least one moisture sensor (11), and the component temperature (T_{K}), the mixer unit temperature (T_{M}) and/or the outside temperature (T_{A}) measured or determined via at least one temperature sensor (12; 13; 14) or thermal imaging camera, in order to determine the required mixing time (t_{M}) of the mixer unit (3) on the basis of a concrete formulation (18), taking into account the measured values determined by the sensor system.

11. Device according to claim 10,
characterized in that different concrete recipes (18) are stored in a recipe database (17) connected to the prognosis unit (10).

12. Device according to claim 10,
characterized in that the correction characteristics (19) for recipe-relevant parameters are stored in a correction line database (20) connected to the prognosis unit.

13. Device according to claim 10,
characterized in that the correction characteristics (19) for recipe-relevant parameters are selected from a characteristic curve group comprising: temperature mixing time correction characteristic, speed mixing time correction characteristic.

14. Device according to claim 10,
characterized in that the components to be mixed also comprise concrete admixtures and/or concrete additives whose properties are taken into account by the prognosis unit (10) in accordance with the formulation.

15. Device according to claim 10,
characterized in that the information on a mixing and delivery process, comprising the concrete formulation (18) used, measured temperature values during the mixing and/or transport process, measured moisture values of at least one component of the concrete formulation (18) used, quantities of the components of the concrete formulation (18) used, the predicted mixing time (t_{M}) and correction values thereto and/or the subsequent transport and waiting time are stored in the form of a documentation data record (25) and can be retrieved in a documentation database (24).

16. Concrete mixing plant for the production of ready-mix concrete (1), comprising an electronic device according to any one of claims 10 to 15.

17. Data format of a documentation data record (25) for a concrete mixing plant for the production of ready-mixed concrete (1) or mixed concrete, at least comprising the following data fields (I-VI) associated with an order identifier (26):
used concrete formulation (18),
temperature readings (T) during the mixing and/or transport process,
moisture readings (F) of at least one component used in the concrete mix design (18),
actual quantities (M) of all components used for to the concrete mix design (18),
predicted mixing duration (t_{M}) of the mixer unit (3), and
transport time to with waiting time (t) on construction site.

18. Computer program comprising instructions which, when the program is executed by a computerized device according to any one of claims 10 to 15, cause the computerized device to execute the method according to any one of claims 1 to 9.
